(19) United States
(12) Patent Application Publication
(10) Pub. No.: US 2014/0378019 A1
(43) Pub. Date: Dec. 25, 2014

(54) UV-CROSSLINKABLE, RESIN-MODIFIED ADHESIVE

(71) Applicant: tesa SE, Hamburg (DE)

(72) Inventors: INGA AUKTUN, Norderstedt (DE); MICHAEL SIEBERT, Schenefeld (DE); ALEXANDER PRENZEL, Hamburg (DE); STEPHAN ZÖLLNER, Buchholz/Nordheide (DE)

(73) Assignee: tesa SE, Hamburg (DE)

(21) Appl. No.: 14/307,716

(22) Filed: Jun. 18, 2014

(30) Foreign Application Priority Data
Jun. 20, 2013 (DE) 10 2013 211 628.4

(51) Int. Cl. C09J 165/02; H01B 7/02; B29C 63/08; C09J 133/08

(52) U.S. Cl. CPC C09J 165/02; C09J 133/08; H01B 7/0241; B29C 63/08; B29K 2033/08
USPC 442/151; 525/132; 428/345; 428/341; 428/377; 156/195

(57) ABSTRACT

The aim is to reduce the flagging tendency of an adhesive bond using a UV-crosslinkable adhesive. This aim is accomplished by provision of a composition which comprises at least one UV-crosslinkable polyacrylate and at least one terpene-phenolic resin, the total concentration of the terpene-phenolic resins being 1 to 5 wt %, based on the total weight of the composition. The invention additionally relates to a pressure-sensitive adhesive produced on the basis of this composition, an adhesive tape based on said adhesive and the use of said tape for wrapping elongate material such as cable harnesses, for example.

This application claims priority of German Patent Application No. 10 2013 211 628.4, filed Jun. 20, 2013, the entire contents of which is hereby incorporated herein by reference.

The invention relates to the technical field of crosslinkable hotmelt adhesives, especially of UV-crosslinkable polyacrylate hotmelt adhesives of the kind used, for example, for producing pressure-sensitive adhesives. In particular, the invention proposes a polyacrylate-based adhesive for producing an adhesive tape having improved flagging characteristics.

Hotmelt adhesives are acquiring increased importance in industrial bonding processes. Because they can be processed solventlessly, they permit processes with a low resource impact, in particular by dispensing with the costly and inconvenient removal of the solvent following delivery of the adhesive. Within the field of adhesive tape manufacture, a common procedure is to apply the adhesive from the melt to a carrier and then crosslink it thermally or by means of radiation, to form polymers of relatively high molecular mass. The adhesives to be processed in this way are also referred to as crosslinkable hotmelt adhesives.

An important and frequently practised method for the crosslinking of pressure-sensitive hotmelt adhesives in particular, is that of UV-initiated crosslinking. In terms of UV-crosslinkable pressure-sensitive hotmelt adhesives of the kind needed for adhesive tapes, there are in principle two polymer systems available. On the one hand, acrylate polymers which are increasingly being equipped with copolymerized photoreactive groups; and on the other hand, styrene block copolymers with free vinyl groups. In the case of the styrene block copolymers it is usually mandatory to add a photoinitiator. The UV-crosslinkable acrylate systems are presently more widespread than systems based on styrene block copolymers.

Advantages of acrylate PSAs (pressure-sensitive adhesives) include the possibility of using a multiplicity of different comonomers for the polymerization and hence the capacity to vary the technical adhesive properties. Comonomers employed as a principal component typically comprise alkyl esters of acrylic and methacrylic acid, in smaller fractions, for example acrylic acid, methacrylic acid, acrylamides, maleic anhydride, hydroxyacrylates or itaconic acid are copolymerized. For the preparation of the polyacrylates, the radical polymerization in solution or in emulsion is employed. Both technologies have problems, but are very favourably priced and have therefore long been carried out on an industrial scale.

A process for preparing a polyacrylate PSA via a hotmelt process is described in WO 02/28963 A2, for example. It involves adding a polyfunctional α-splitter, present in oligomeric form, to the polymer to be crosslinked, prior to processing in the hotmelt process; UV crosslinking then takes place after processing.

A composition based on a meltable, UV-crosslinkable polyacrylate is subject matter of WO 2004/083302 A1. The composition is used as a hotmelt adhesive. It comprises an oligomeric compound having UV-crosslinkable functional groups which are reactive with the polyacrylate.

By its nature, the UV crosslinking and the consequent formation of polymer chains with a relatively high molecular weight brings about an increase in the cohesion within the adhesive. On the other hand, as the degree of crosslinking goes up, the adhesion is lowered considerably. A weighted balance between cohesion and adhesion is very important in terms, for example, of what are called the “flagging” characteristics of the adhesive.

In the case of an adhesive tape wound around a body, flagging is understood as the propensity for one end of the adhesive tape to “stick out”, in other words the attempt to return to a planar form from an angled or rounded form. This is relevant, for example, in the case of adhesive tapes used for the jacketing of cables for the purposes of insulating or of bundling a plurality of cables. In this scenario, pronounced flagging results in the adhesive tape standing up and, as a consequence, unrolling, with the worst-case outcome of regions of the cable that are supposed to be insulated being exposed again, or of the bundling of cables becoming undone.

The extent of the flagging is determined essentially by the interaction of the holding force produced by the adhesive, the stiffness of the carrier, and the diameter of the cable harness.

It has been found that in the case of polyacrylate compositions without resin admixture, the cohesion-adhesion ratio can be controlled only within an extremely narrow range. Even at low UV doses, excessive crosslinking may occur, so that the adhesion maximum cannot be stably established. Under these conditions, variations in properties of the adhesives through altered machine parameters are rarely possible, since the profile of properties is determined almost entirely by the degree of crosslinking. For this reason, generally speaking, UV-crosslinkable polyacrylate compositions are blended with resins and/or fillers, since in this case there is a larger operating window for the tailoring of cohesion and adhesion to one another.

The primary objective of blends with resins is generally that of raising the adhesion. If this is done using resins having a low softening point, such as rosins, for example, there is nevertheless a consequent lowering in the cohesion of the composition. if resins with a very high softening point are employed, the cohesion can be improved again. At the same time, however, there is a deterioration in the flow behaviour by comparison with the unblended composition. As a result, it becomes very difficult to ensure the consistency over time of the balance between adhesion and cohesion. It is this balance, however, which is very important especially for adhesive tapes for cable wrapping.

Resins are usually used in a weight fraction well above 10%—frequently, for example, at about 15% to 50%—in order to achieve a significant influence by the resin on the adhesion. More detailed information on the state of the art in the field of formulation of UV-crosslinking pressure-sensitive hotmelt adhesives is contained in a publication which appeared in “adhäsion Kleben & Dichten”, Volume 49, Issue 5, pages 27-31 (A. Dobmann, B. Blickenstorfer; Collano A G).

In summary, it can be stated that there is an ongoing need for UV-crosslinked PSAs with a stable profile of properties, in particular with a stable cohesion-adhesion ratio.

It is an object of the invention, therefore, to provide a UV-crosslinkable composition which once crosslinking has taken place, produces a pressure-sensitive hotmelt adhesive with a balanced profile of technical adhesive properties, and in particular with a very low flagging propensity. The composition is also to be combinable with a large number of carrier materials, including, in particular with woven fabric carriers.

Surprisingly, it has emerged that the object can be achieved through the admixing of terpene-phenolic resins at an unexpectedly low concentration.

The invention accordingly first provides a composition which comprises at least one UV-crosslinkable polyacrylate and at least one terpene-phenolic resin, the total concentration of the terpene-phenolic resins being 1 to 5 wt %, based on the total weight of the composition. A pressure-sensitive adhesive obtained from a composition of this kind exhibits a significantly reduced repulsion tendency and is also notable for properties including high bond-strength and elasticity values and also satisfactory holding power times.

A “polyacrylate” is understood to mean a polymer which is obtainable generally by radical polymerization of acrylic and/or methacrylic monomers and also, optionally, of further, copolymerizable monomers. The acrylic and/or methacrylic acid monomers include, in accordance with the invention, not only acrylic and/or methacrylic acid but also acrylic and/or methacrylic esters. A polyacrylate more particularly means a polymer whose monomer basis is made up to an extent of at least 30 wt % of acrylic acid, methacrylic acid, acrylic esters and/or methacrylic esters, with acrylic esters and/or methacrylic esters generally being present at least proportionally, preferably at not less than 30 wt %, based on the total weight of the polymer.

### BRIEF DESCRIPTION OF THE DRAWINGS

The invention will now be described in greater detail with reference to the drawings, wherein:

FIG. 1 shows the schematic construction of a device for use in determining flagging resistance;

FIG. 2 is an assembly used in testing flagging resistance;

FIG. 3 is a later in time view of the assembly used in testing flagging resistance; and

FIG. 4 is a still later in time view of the assembly used in testing flagging resistance.

The at least one UV-crosslinkable polyacrylate in the composition of the invention may be based preferably on a monomer mixture which comprises the following components:
a) 65 to 100 wt % of (meth)acrylic acid and (meth)acrylic acid derivatives of the general formula

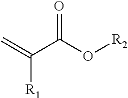

where R₁=H or CH₃ and R₂ is an alkyl chain having from 1 to 20 C atoms,
b) 0 to 35 wt % of vinyl compounds having functional groups,
   the sum total of all the monomers used being 100 wt %.

The polymer to be crosslinked is preferably prepared via a free or controlled radical polymerization. The polymerization may be carried out in polymerization reactors which are equipped in general with a stirrer, a number of feed vessels, reflux condenser, heating and cooling, and are fitted out for operation under N₂ atmosphere and superatmospheric pressure.

The radical polymerization is typically conducted in the presence of one or more organic solvents and/or in the presence of water or in bulk. The aim here is to minimize the amount of solvent used. Depending on conversion rate and temperature, the polymerization time is between 6 and 48 hours. The weight-average molecular weight (determined by size exclusion chromatography) of the polymers varies between 300 000 and 2 000 000 g/mol, preferably between 600 000 and 1 200 000 g/mol.

For the solution polymerization, solvents used are preferably esters of saturated carboxylic acids (such as ethyl acetate), aliphatic hydrocarbons (such as n-hexane or n-heptane), ketones (such as acetone or methyl ethyl ketone), special boiling-point spirit, or mixtures of these solvents. Great preference is given to using a solvent mixture of acetone and isopropanol, with the isopropanol content lying between 1 and 10 percent by weight. Polymerization initiators used are customary radical-forming compounds such as peroxides and azo compounds, for example. Initiator mixtures may also be used. In the polymerization it is also possible to employ thiols as further regulators for molecular weight lowering and reduction in the polydispersity. Further such polymerization regulators—chain transfer agents, as they are known—used may be alcohols and ethers, for example.

The at least one UV-crosslinkable polyacrylate in the composition of the invention is preferably a meltable polyacrylate, meaning that it can be applied to a carrier from the melt.

In order to boost the crosslinking efficiency, the non-crosslinked polymers are blended optionally with crosslinkers: suitable crosslinker substances for this purpose are, for example, di- or polyfunctional (meth)acrylates. Use may also be made here, however, of all further difunctional or polyfunctional compounds which are familiar to the skilled person, and are capable of crosslinking polyacrylates.

In accordance with the common general knowledge, a terpene-phenolic resin is understood to be a resin obtainable by acid-catalysed addition of phenols onto terpenes. The terpene basis of the terpene-phenolic resin consists preferably of α-pinene, β-pinene, Δ-3-carene and/or limonene. With preference in accordance with the invention, the total concentration of the terpene-phenolic resins, based on the total weight of the composition of the invention, is 2 to 4 wt %, more preferably 2.5 to 3.5 wt %.

The terpene-phenolic resin preferably has a softening temperature (Ring & Ball softening point, measured in accordance with ASTM E28-99) of at least 90° C., more preferably of at least 105° C., more particularly of at least 110° C. With particular preference the terpene-phenolic resin has a softening temperature of 95 to 135° C.

Additionally provided by the invention is a pressure-sensitive adhesive which is obtainable by UV-crosslinking a composition of the invention. UV crosslinking takes place preferably at a UV dose of <100 mJ/cm², more preferably of <80 mJ/cm², very preferably of <60 mJ/cm², for example of <35 mJ/cm².

The PSA of the invention may comprise one or more additives such as, for example, primary and secondary ageing inhibitors, light stabilizers and ozone protectants. It may additionally comprise one or more fillers such as fibres, carbon black, zinc oxide, titanium dioxide, solid microbeads, silica, silicates and/or chalk. The addition is also possible of other thermal crosslinkers, such as of isocyanates, for example, more particularly of isocyanates blocked with UV protection groups, and also of further thermal crosslinkers known to the skilled person.

Further provided by the invention is an adhesive tape obtainable by applying a composition of the invention from the melt to a carrier and UV-crosslinking the composition. The composition is applied preferably with a weight per unit area of 20 to 120 g/m², more preferably of 40 to 100 g/m², very preferably of 60 to 80 g/m². The UV crosslinking takes place preferably at a UV dose of <100 mJ/cm², more preferably of <80 mJ/cm², very preferably of <60 mJ/cm², for example of <35 mJ/cm².

The carrier of the adhesive tape of the invention is preferably a woven fabric, nonwoven or film carrier. If the carrier is a film carrier, particularly preferred film material is polypropylene, more particularly biaxially oriented polypropylene (BOPP), polyethylene terephthalate (PET), polyvinyl chloride (PVC) or polyester. The UV crosslinking takes place advantageously directly on the carrier.

Particularly preferred in accordance with the invention is a textile as carrier, preferably a woven fabric, more particularly a woven polyester fabric, a nonwoven or a knitted fabric. It is further preferred here if the carrier has a basis weight of 30 to 250 g/m², preferably of 50 to 200 g/m², more preferably of 60 to 150 g/m².

As textile carrier, for example, it is possible to use knitted fabrics, scrims, tapes, braids, tufted textiles, felts, woven fabrics (encompassing plain weave, twill and satin weave), knits (encompassing warp knits and other knits) or nonwoven webs, the term “nonwoven web” comprehending at least sheetlike textile structures in accordance with EN 29092 (1988) and also stitch bonded webs and similar systems.

It is likewise possible to use woven and knitted spacer fabrics with lamination. Spacer fabrics are mat-like layer structures comprising a cover layer of a fibre or filament web, an underlayer and individual retaining fibres or bundles of such fibres between these layers, these fibres being distributed over the area of the layer structure, being needled through the particle layer and joining the cover layer and the underlayer to one another. As an additional although not mandatory feature, the retaining fibres contain particles of inert minerals, such as sand, gravel or the like, for example.

The retaining fibres needled through the particle layer hold the cover layer and the underlayer at a distance from one another and are joined to the cover layer and the underlayer.

Nonwovens contemplated include, in particular, consolidated staple fibre webs, but also filament webs, meltblown webs and spunbonded webs, which generally require additional consolidation. Possible consolidation methods known for webs include mechanical, thermal and chemical consolidation. Whereas with mechanical consolidations the fibres are held together purely mechanically usually by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to fibre nodal points, so that a stable, three-dimensional network is formed while nevertheless retaining the relatively loose, open structure in the web.

Webs which have proved to be particularly advantageous are those consolidated in particular by overstitching with separate threads or by interlooping.

Consolidated webs of this kind are produced for example on stitchbonding machines of the “Malimo” type from the company Karl Mayer, formerly Malimo, and can be obtained from companies including Techtex GmbH. A Malifleece is characterized in that a cross-laid web is consolidated by the formation of loops from fibres of the web.

The carrier used may also be a web of the Kunit or Multiknit type. A Kunit web is characterized in that it originates from the processing of a longitudinally oriented fibre web to form a sheetlike structure which has loops on one side and has loop feet or pile fibre folds on the other side, but possesses neither threads nor prefabricated sheetlike structures. A web of this kind as well has been produced for a relatively long time, for example on stitchbonding machines of the “Malimo” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching. The starting product used for a Multiknit is generally one or two single-sidedly interlooped pile fibre nonwovens produced by the Kunit process. In the end product, both top sides of the nonwovens are shaped by means of interlooped fibres to form a closed surface, and are joined to one another by fibres which stand almost perpendicularly. An additional possibility is to introduce further needlable sheetlike structures and/or scatterable media.

Finally, stitchbonded webs as an intermediate are also suitable for forming a carrier of the invention and an adhesive tape of the invention. A stitchbonded web is formed from a nonwoven material having a large number of stitches extending parallel to one another. These stitches are brought about by the stitching-in or stitchbonding of continuous textile threads. For this type of web, stitchbonding machines of the “Malimo” type from the company Karl Mayer are known.

Also particularly suitable are needlefelt webs. In a needlefelt web, a tuft of fibres is made into a sheetlike structure by means of needles provided with barbs. By alternate introduction and withdrawal of the needles, the material is consolidated on a needle bar, with the individual fibres interlooping to form a firm sheetlike structure. The number and configuration of the needling points (needle shape, penetration depth, double-sided needling) determine the thickness and strength of the fibre structures, which are in general lightweight, air-permeable and elastic.

Also particularly advantageous is a staple fibre web which is mechanically preconsolidated in the first step or is a wet-laid web laid hydrodynamically, in which between 2% and 50% by weight of the web fibres are fusible fibres, more particularly between 5% and 40% by weight of the web fibres. A web of this kind is characterized in that the fibres are laid wet or, for example, a staple fibre web is preconsolidated by the formation of loops from fibres of the web by needling, stitching, air-jet and/or water-jet treatment. In a second step, thermofixing takes place, with the strength of the web being increased again by the melting, or partial melting, of the fusible fibres.

For the utilization of nonwovens in accordance with the invention, the adhesive consolidation of mechanically preconsolidated or wet-laid webs is of particular interest, it being possible for said consolidation to take place by way of the addition of binder in solid, liquid, foamed or paste-like form. A great diversity of theoretical presentation forms is possible: for example, solid binders as powders for trickling in; as a sheet or as a mesh; or in the form of binding fibres. Liquid binders may be applied as solutions in water or organic solvents, or as a dispersion. For adhesive consolidation, binding dispersions are predominantly selected: thermosets in the form of phenolic or melamine resin dispersions, elastomers as dispersions of natural or synthetic rubbers or, usually, dispersions of thermoplastics such as acrylates, vinyl acetates, polyurethanes, styrene-butadiene systems, PVC, and the like, and also copolymers thereof. Normally the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” [Nonwovens] (Georg Thieme Verlag, Stuttgart, 1982) or “Textiltechnik-Vliesstofferzeugung” [Textile Technology—Producing Nonwovens] (Arbeitgeberkreis Gesamttextil, Eschborn, 1996).

For mechanically preconsolidated webs which already possess sufficient composite strength, the single-sided spray application of a binder is appropriate for producing specific changes in the surface properties. Such a procedure is not only sparing in its use of binder but also greatly reduces the energy requirement for drying. Since no squeeze rolls are required and the dispersions remain predominantly in the upper region of the nonwoven, unwanted hardening and stiffening of the web can be largely prevented. For sufficient adhesive consolidation of the web carrier, the addition of binder in the order of magnitude of 1% to 50%, more particularly 3% to 20%, based on the weight of the fibre web, is generally required.

The binder may be added as early as during the manufacture of the web, in the course of mechanical preconsolidation, or else in a separate process step, which may be carried out in-line or off-line. Following the addition of binder, it is necessary temporarily to generate a condition for the binder in which the binder becomes adhesive and adhesively connects the fibres—this may be achieved during the drying, for example, of dispersions, or else by means of heating, with further possibilities for variation existing by way of areal or partial application of pressure. The binder may be activated in known drying tunnels, given an appropriate selection of binder, or else by means of infra-red radiation, UV radiation, ultra-sound, high-frequency radiation or the like. For the subsequent end use it is sensible, though not absolutely necessary, for the binder to have lost its tack following the end of the web production process. It is advantageous that, as a result of thermal treatment, volatile components such as fibre assistants are removed, giving a web having favourable fogging values, so that when a low-fogging adhesive is used, it is possible to produce an adhesive tape having particularly favourable fogging values; accordingly, the carrier as well has a very low fogging value.

A further special form of adhesive consolidation involves activating the binder by partial dissolution or partial swelling. In this case it is also possible in principle for the fibres themselves, or admixed speciality fibres, to take over the function of the binder. Since, however, such solvents are objectionable on environmental grounds, and/or are problematic in their handling, for the majority of polymeric fibres, this process is not often employed.

Advantageously and at least in regions, the carrier may have a single-sidedly or double-sidedly polished surface, preferably in each case a surface polished over the whole area. The polished surface may be chintzed, as elucidated in detail in EP 1 448 744 A1, for example. Dirt repellency is hereby improved.

Starting materials for the carrier are more particularly (manmade) fibres (staple fibre or continuous filament) made from synthetic polymers, also called synthetic fibres, made from polyester, polyamide, polyimide, aramid, polyolefin, polyacrylonitrile or glass, (manmade) fibres made from natural polymers such as cellulosic fibres (viscose, Modal, Lyocell, Cupro, acetate, triacetate, Cellulon), such as rubber fibres, such as plant protein fibres and/or such as animal protein fibres and/or natural fibres made of cotton, sisal, flax, silk, hemp, linen, coconut or wool. The present invention, however, is not confined to the materials stated; it is instead possible to use a multiplicity of further fibres in order to produce the nonwoven. Likewise suitable, furthermore, are yarns fabricated from the fibre materials specified.

In the case of woven fabrics or scrims, individual threads may be produced from a blend yarn, and thus may have synthetic and natural constituents. Generally speaking, however, the warp threads and the weft threads are each formed of a single kind.

The warp threads and/or the weft threads here may in each case be composed only of synthetic threads or only of threads made from natural raw materials.

Preferred material used for the carrier is polyester, owing to the outstanding ageing resistance and the outstanding resistance to media, namely with respect to chemicals and service fluids such as oil, fuel, antifreeze and similar. Polyester, moreover, has the advantage that it leads to a very abrasion-resistant and temperature-stable carrier, which is particularly important for the specific utility for the bundling of cables in motor vehicles and, for example, in the engine compartment.

Also suitable for the wrapping of elongate material is a carrier made of paper, of a laminate, of a film (for example PP, PE, PET, PA, PU), of foam or of a foamed film.

These non-textile sheet-like materials are especially appropriate when specific requirements dictate that the invention be modified in such a way. In comparison to textiles, for example, films are usually thinner, afford additional protection—by virtue of the closed layer—against the penetration of chemicals and service fluids such as oil, petrol, antifreeze and so on, in a wrapped cable region, for example, and can be largely adapted to the requirements through a suitable selection of the material: with polyurethanes and/or polyolefin copolymers, for example, flexible and elastic wrappings can be produced; with polyester and/or polyamides, good abrasion resistance and temperature resistance qualities are obtained.

Foams or foamed films, in contrast, have the property of greater bulk and also effective noise suppression—where a cable strand is laid in a channel-like or tunnel-like area within the vehicle, for example, a jacketing tape of appropriate thickness and suppression is able to prevent disruptive flapping and vibrating from the outset.

The invention further provides for the use of a composition of the invention for preparing a pressure-sensitive adhesive. Additionally provided by the invention is the use of a composition of the invention for application to a carrier material or to a carrier. A further subject of the invention is the use of a composition of the invention for producing adhesive tapes for cable jacketing (wire harnessing tapes).

A further subject of the invention is the use of a pressure-sensitive adhesive of the invention for producing adhesive tapes for cable jacketing (wire harnessing tapes). A further subject of the invention is the use of a pressure-sensitive adhesive of the invention as an adhesive of an adhesive tape for cable jacketing (wire harnessing tape).

The invention additionally provides for the use of an adhesive tape of the invention for jacketing elongate material, with the adhesive tape being guided in a helical line around the elongate material.

The invention additionally provides for the use of an adhesive tape of the invention for jacketing elongate material, with the elongate material being enveloped in axial direction by the adhesive tape.

The invention additionally provides an elongate material, more particularly a cable harness, which is jacketed with an adhesive tape of the invention.

### EXAMPLES

### Tests Conducted:

Flagging characteristics—TFT

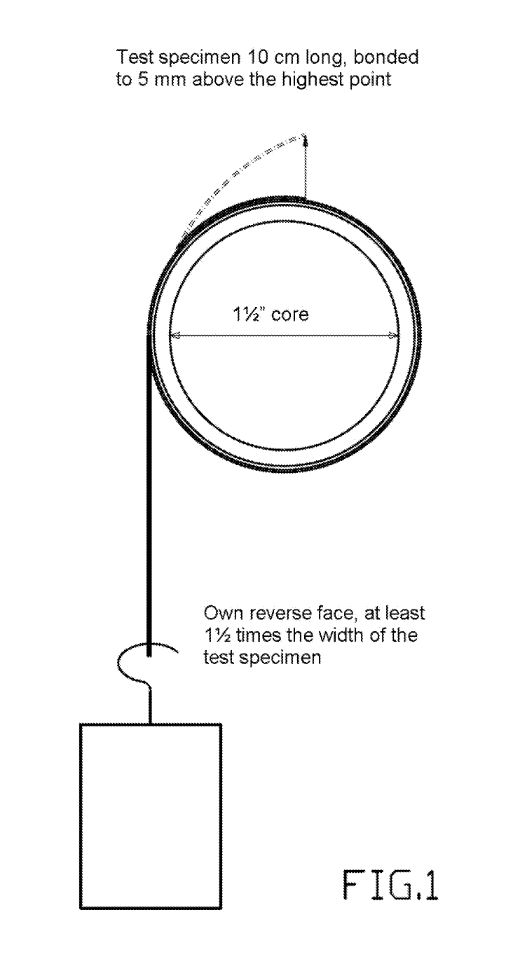

The flagging resistance was determined by the so-called TFT (Threshold Flagging Time) method. With this method, a test is employed in which an additional flexural stress is generated by the application of the test specimens, prepared in a flat format, to a 1½ core. The combination of tensile load by a test weight and flexural stress causes flagging-like detachment of the adhesive tape, starting from the bonded upper end, and ultimate failure by dropping of the test specimens (see FIG. 1, which also shows the schematic construction).

The time in minutes before dropping is the result.

The critical parameters for the holding time of the test specimens are weight and temperature, the weight being selected such as to result in values of at least 100 minutes.

The test mandrel is a 1½″ card core with an external diameter of 42±2 mm, provided with a marking line 5 mm adjacent to the vertex line.

The adhesion base is the adhesive tape's own reverse face.

The manual roller has a weight of 2 kg.

The test weight is 1 kg.

The test conditions are 23±1° C. at 50±5% relative humidity, or 40° C. in the heating cabinet.

The test is carried out on strips of adhesive tape 19 mm wide. A strip with a length of 400 mm is adhered to release paper and cut to form three strips with a length of 100 mm each. This should be done using a fresh cutter blade. The reverse face must not be touched.

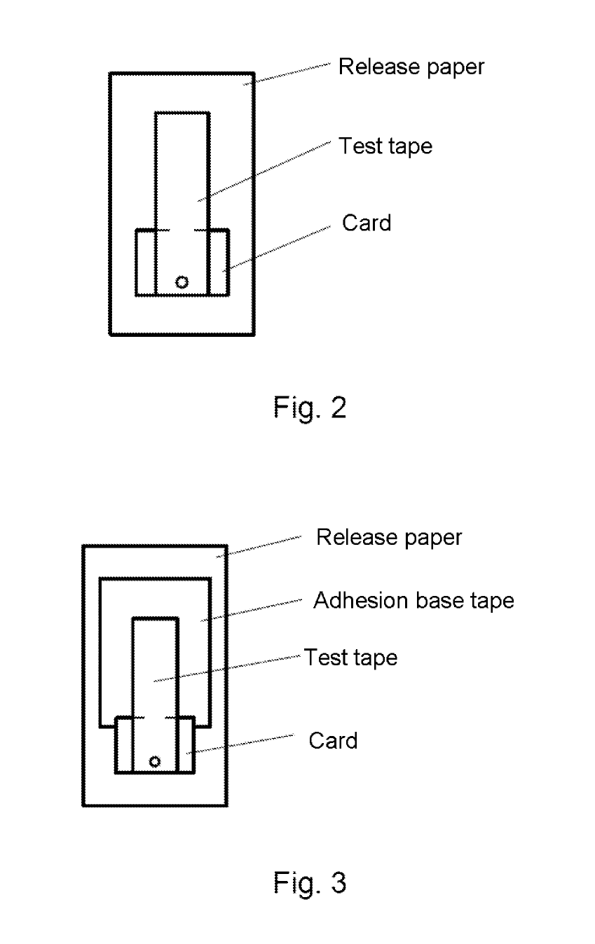

A small piece of card is adhered beneath one of the ends of each strip, and the assembly is perforated (see FIG. 2).

The test strips are then individually bonded centrally to strips of the broader adhesion base (adhesive tape with a width 1½ times that of the adhesive tape under test), so that the small piece of card still overlaps just (2 to 3 mm) at the end (see FIG. 3).

The test specimens are rolled down using the 2 kg manual roller in 3 cycles with a speed of 10 m/min.

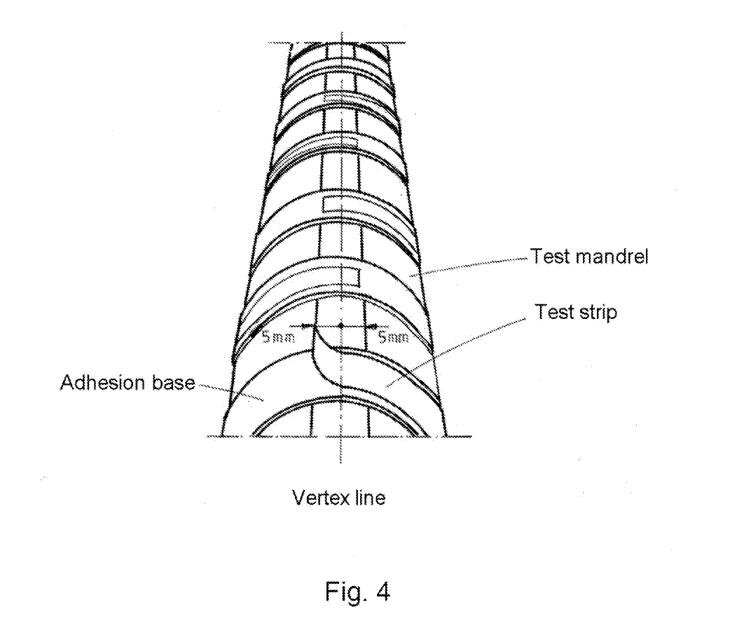

The completed test samples are then adhered to the card core in such a way that the upper end of the test specimen overlaps the vertex point by 5 mm (see FIG. 4). In this operation, only the adhesion base, and not the test specimen, must be pressed on.

The fully prepared test specimens are left for 20±4 hours without weight loading in a controlled climate chamber at 40° C.

Weights with a mass of one kilogram are then hung onto the specimens, and the stopwatches are started.

Measurement ends after failure of all three test specimens of one sample.

The median of the three individual measurements is reported, in minutes.

Bond strength to steel 90°.

The bond strength to steel is determined under test conditions of 23° C.+/−1° C. temperature and 50%+/−5% relative humidity. The samples are cut to a width of 20 mm and adhered to a steel plate. Prior to the measurement, the steel plate is cleaned and conditioned. For this purpose the plate is first wiped down with acetone and then left to stand in the air for 5 minutes to allow the solvent to evaporate. This is followed by the rolling of the test sample onto the steel substrate. For this purpose, the tape is rolled down five times back and forth with a 2 kg roller, at a rolling speed of 10 m/min. Immediately following roller application, the steel plate is inserted into a special mount that allows the sample to be peeled off vertically upward at an angle of 90°. The bond strength is measured using a Zwick tensile testing machine. The results are reported in N/cm as averages obtained from three measurements.

Bond strength to reverse face 90°

The reverse face bond strength was determined as for the determination of the bond strength for steel with the difference that first of all an adhesive tape 51026 (Tesa®, single-sided adhesive tape with woven PET fabric reverse face) was adhered to the steel plate. The sample for testing was then adhered to this tape. The further test procedure is in line with the bond strength to steel test.

### Holding Power Time

A strip of the adhesive tape 13 mm wide and more than 20 mm long (30 mm for example) is applied to a smooth steel surface which has been cleaned three times with acetone and once with isopropanol. The bond area is 20 mm×13 mm (length×width), the adhesive tape protruding beyond the test plate at the edge (by 10 mm, for example, corresponding to the aforementioned length of 30 mm). The adhesive tape is subsequently pressed onto the steel support four times, with an applied pressure corresponding to a weight of 2 kg. This sample is suspended vertically, with the protruding end of the adhesive tape pointing downwards.

At room temperature a weight of 1 kg is affixed to the protruding end of the adhesive tape. Measurement is conducted under standard conditions (23° C.+/−1° C., 55%+/−5% atmospheric humidity).

The holding power times measured (times taken for the adhesive tape to detach completely from the substrate; measurement terminated at 10 000 minutes) are reported in minutes and correspond to the average value from three measurements.

### Microshear Test

This test serves for the accelerated testing of the shear strength of adhesive tapes under temperature load.

### Sample Preparation:

An adhesive tape (length about 50 mm, width 10 mm) cut from the respective sample specimen is adhered to a steel test plate, which has been cleaned with acetone, in such a way that the steel plate protrudes beyond the adhesive tape to the right and the left, and that the adhesive tape protrudes beyond the test plate by 2 mm at the tope edge. The bond area of the sample in terms of height×width=13 mm×10 mm. The bond site is subsequently rolled over six times with a 2 kg steel roller at a speed of 10 m/min. The adhesive tape is reinforced flush with a stable adhesive strip which serves as a support for the travel sensor. The sample is suspended vertically by means of a test plate.

### Microshear Test:

The sample specimen for measurement is loaded at the bottom end with a weight of 100 g. The test temperature is 40° C., the test duration is 30 minutes (15 minutes' loading and 15 minutes' unloading). The shear travel after the predetermined test duration at constant temperature is reported as the result, in μm, as both the maximum value [“max”; maximum shear travel as a result of 15-minute loading]; as minimum value [“min”; shear travel (“residual deflection”) 15 minutes after unloading; on unloading there is a backward movement as a result of relaxation]. Likewise reported is the elastic component in percent [“elast”; elastic fraction=(max−min)×100/max].

### Production of the Adhesive Tapes

acResin A 260 UV (BASF) was dissolved in butanone and terpene-phenolic resin DT110 (from DRT resins, France) was incorporated up to the concentration reported in Table 1 (wt %, based on the mass of acResin A 260 UV). The solution obtained was coated using a coating bar onto a 75 μm thick PET film with a basis weight of 60 g/m², and dried. The composition was then crosslinked with a laboratory UV unit, using the UV dose reported in Table 1.

The test results are contained in Table 1.

TABLE 1
Examples and test results

| | | UV | | BSS | BSR | | |
|---|---|---|---|---|---|---|---|
| | Resin | dose | | 90°, | 90°, | HPT | MST/ |
| | fraction | (mJ/ | TFT | 24 h | 24 h | 10 N | elast. |
| No. | (wt %) | cm²) | (min) | (N/cm) | (N/cm) | (min) | (%) |
| 1 | 0 | 20 | 274 | 11 | 4 | 306 | 91 |
| (Comp.) | | | | | | | |
| 2 | 3 | 20 | 404 | 13 | 5 | 27 | 61 |
| 3 | 15 | 20 | 83 | 17 | 8 | 0 | 0 |
| (Comp.) | | | | | | | |
| 4 | 0 | 40 | 64 | 7 | 2 | 336 | 91 |
| (Comp.) | | | | | | | |
| 5 | 3 | 35 | 751 | 12 | 10 | 393 | 84 |
| 6 | 0 | 120 | 6 | 6 | 2 | 273 | 83 |
| (Comp.) | | | | | | | |
| 7 | 15 | 120 | 499 | 14 | 4 | 71 | 39 |
| (Comp.) | | | | | | | |
| 8 | 15 | 200 | 658 | 11 | 4 | n.m. | 53 |
| (Comp.) | | | | | | | |

Comp. = Comparative example, not inventive
n.m. = not measured

The results show that through the use of a terpene-phenolic resin in the concentration range according to the invention, the flagging propensity is reduced significantly. In order to achieve such a reduction in the flagging tendency (expressed by similarly high values in the TFT test), a UV dose of more than 120 mJ/cm² must be selected in the case of high resin concentrations (15%). The corresponding adhesive tapes do display a performance comparable in principle to that of the adhesive tapes of the invention, but the spectrum of carriers that can be used is very greatly restricted. Thus it was found, for example, that when using woven PET fabric as a carrier for adhesives with a resin content >8%, with UV doses of more than 100 mJ/cm², and in spite of the use of chill rolls, the heating experienced by the carrier was such that it underwent decomposition, giving off smoke copiously as it did so.

1. Composition comprising at least one UV-crosslinkable polyacrylate and at least one terpene-phenolic resin, the total concentration of the terpene-phenolic resins being 1 to 5 wt % based on the total weight of the composition.

2. Composition according to claim 1, wherein the total concentration of the terpene-phenolic resins is 2 to 4 wt %, based on the total weight of the composition.

3. Composition according to claim 1, wherein the total concentration of the terpene-phenolic resins is 2.5 to 3.5 wt %, based on the total weight of the composition.

4. Composition according to claim 1, wherein the terpene-phenolic resin has a softening temperature (Ring & Ball softening point, measured in accordance with ASTM E28-99) of at least 90° C.

5. Pressure-sensitive adhesive obtainable by UV-crosslinking a composition according to claim 1.

6. Pressure-sensitive adhesive according to claim 5, wherein the UV crosslinking takes place at a UV dose of <100 mJ/cm².

7. Adhesive tape obtained by applying a composition according to claim 1 from the melt to a carrier and UV-crosslinking the composition.

8. Adhesive tape according to claim 7, wherein the composition is applied with a weight per unit area of 20 to 120 g/m².

9. Adhesive tape according to claim 7, wherein the UV crosslinking takes place at a UV dose of <100 mJ/cm².

10. Adhesive tape according to claim 7, wherein the carrier is a woven fabric, nonwoven or film carrier.

11. Method of using a composition according to claim 1 for producing a pressure-sensitive adhesive.

12. Method of using a composition according to claim 1 for producing adhesive tapes for cable wrapping.

13. Method of using a pressure-sensitive adhesive according to claim 5 for producing adhesive tapes for cable wrapping.

14. A method for wrapping elongate material, said method comprising guiding an adhesive tape according to claim 7 in a helical line around the elongate material.

15. A method for wrapping elongate material, said method comprising enveloping elongate material in an axial direction by an adhesive tape according to claim 7.

16. Elongate material wrapped with an adhesive tape according to claim 7.
